(19) United States
(12) Patent Application Publication
(10) Pub. No.: US 2011/0145648 A1
(43) Pub. Date: Jun. 16, 2011

(54) Method and Apparatus for Power Diagnostics

(75) Inventors: Charles Garcia-Tobin, Cambridge (GB); Adam Johnston, Cambridge (GB); Kwok-Lun Fung, Hong Kong (CN)

(73) Assignee: NOKIA CORPORATION, Espoo (FI)

(21) Appl. No.: 13/060,010

(22) PCT Filed: Aug. 19, 2009
(86) PCT No.: PCT/IB2009/053656

§ 371 Date: Feb. 21, 2011

(30) Foreign Application Priority Data
Aug. 21, 2008 (GB) 0815322.3

(51) Int. Cl. G06F 11/34; G06F 11/07; G06F 11/32

(52) U.S. Cl. 714/37; 714/45; 714/E11.029; 714/E11.2; 714/E11.184

(57) ABSTRACT

A diagnostic tool (60) for identifying a software program (30; 32; 34; 36) which is responsible for a change in the power consumption of a device (10) comprising a plurality of elements (12; 16; 18; 20; 22) wherein each element (12; 16; 18; 20; 22) has an associated resource (38; 40; 42; 44; 46) which reflects an operational state of the element (12; 16; 18; 20; 22), the diagnostic tool (60) comprising an acquisition module (48) for collecting information relating to the resources and a display (52) for displaying the state of the resources (38; 40; 42; 44; 46) against a common time base such that a change in the state of a resource (38; 40; 42; 44; 46) at a given time can be detected and the software program (30; 32; 34; 36) responsible for causing the change can be identified.

### TECHNICAL FIELD

Embodiments of the present invention relate to the field of diagnosis of software and power dependencies.

### BACKGROUND TO EMBODIMENTS OF THE INVENTION

Computing devices such as mobile telephone handsets include a number of hardware components such as a processor, a digital camera, a display, hardware clocks, buses, a positioning system receiver and components relating to the making and receiving of telephone calls. Each of the hardware components requires power to operate. The amount of power that any one hardware component may consume may vary depending on the function provided by that component and such components have multiple power states. The functionality, and therefore the state, of hardware components is generally controlled by software programs.

### SUMMARY OF EMBODIMENTS OF THE INVENTION

According to a first embodiment of the invention, an apparatus is provided, said apparatus comprising:
at least one processor
and at least one memory including computer program code
the at least one memory and the computer program code configured to, with the at least one processor, cause the apparatus to:
   collect information using an acquisition module, said information relating to a plurality of elements of a computing device having two or more operational states, said information relating to a change of an operational state of said elements, said computing device further comprising one or more software programs which change an operational state of at least one of said elements, and
   arrange said information for display of an operational state of the elements against a common time base.

The arranged information may be displayed on a display so that the state of one or more of the elements is displayed against a common time base. The display of the state of the elements against a common time base may be such that a change in the state of an element at a given time can be detected and the software program responsible for causing the change can be identified.

At least one of the elements may have an identifier associating the element with one or more of said software programs.

The information may be arranged to display an estimate of the total power consumption of the computing device against the common time base.

The acquisition module may be a piece of software which runs inside the computing device.

The acquisition module may be configured to collect information relating to events which affect a processor of the computing device.

The acquisition module may be configured to collect information relating to power modes of the computing device.

The information may be arranged to display the information relating to power modes of the computing device and the information relating to the elements against the common time base.

The acquisition module may be configured to collect information relating to timers of the computing device.

The display module may be configured to arrange information relating to an estimate of the total power consumption of the computing device against the common time base.

The display module may be configured to arrange information relating to power modes of the computing device and the information relating to the elements against the common time base.

According to a further embodiment of the invention, there is provided a method, the method comprising:
collecting information with use of an acquisition module, said information relating to a plurality of elements of a computing device having two or more operational states, said information relating to a change of an operational state of said elements, said computing device further comprising one or more software programs which change a state of at least one of said elements, and
arranging said information for display of an operational state of the elements against a common time base.

The arranged information may be displayed on a display so that the state of one or more of the elements is displayed against a common time base. The display of the state of the elements against a common time base may be such that a change in the operational state of an element at a given time can be detected and the software program responsible for causing the change can be identified.

At least one of the elements may have an identifier associating the element with one or more of the plurality of software programs.

The method may further comprise arranging the information to display an estimate of the total power consumption of the computing device.

The acquisition module may be a piece of software which runs inside the computing device.

Information relating to events which affect a processor of the computing device may be collected by the acquisition module.

Information relating to power modes of the computing device may be collected by the acquisition module.

The information relating to power modes of the computing device and the information relating to the elements may be arranged for display against the common time base.

Information relating to timers of the computing device may be collected by the acquisition module.

According to a further embodiment of the invention, a computer readable medium is provided, the computer readable medium storing instructions, said instructions being such that when processed by a processor configure said processor to:
collect information relating to a plurality of elements of a computing device having two or more operational states, said information relating to a change of an operational state of said elements, said computing device further comprising one or more software programs which change an operational state of at least one of said elements, and
arrange said information for display of an operational state of the elements against a common time base.

The processor may operate in a computing device different from the computing device in respect of which the information is collected or may operate on the same computing device in respect of which the information is collected.

According to a further embodiment of the invention a diagnostic tool is provided, the diagnostic tool comprising:
an acquisition module for collecting information relating to a plurality of elements of a computing device having two or more operational states, said acquisition module collecting information relating to a change of an operational state of said elements, said computing device further comprising one or more software programs which change an operational state of at least one of said elements,
said diagnostic tool further comprising a display for displaying an operational state of the elements against a common time base.

According to a further embodiment of the invention a method is provided, the method comprising:
monitoring a power state of at least a first and a second hardware component of a computing device, said power state of said first hardware component being alterable by one or more software instructions,
comparing a change in said power state of said first hardware component to said power state of said second hardware component, and
identifying a software instruction which caused said change of said power state of said first hardware component.

According to a further embodiment of the invention, an apparatus is provided, the apparatus comprising:
an acquisition module for collecting information relating to a plurality of elements of a computing device having two or more operational states, said acquisition module collecting information relating to a change of an operational state of said elements, said computing device further comprising one or more software programs which change a state of at least one of said elements,
said apparatus further comprising a display module for arranging said information for display of an operational state of the elements against a common time base.

For multiple embodiments of the invention, the state of an element may be recorded in a resource record and, in this case, the acquisition module may be configured to collect said information by reading resource records. Each of said elements may be a hardware element and may correspond to a resource.

### BRIEF DESCRIPTION OF THE DRAWINGS

Embodiments of the invention will now be described, strictly by way of example only, with reference to the accompanying drawings, of which:

FIG. 1 is a schematic illustration showing components of a device;

FIG. 2 is a schematic illustration showing interactions between software programs of the device shown in FIG. 1;

FIG. 3 is a schematic illustration showing interactions between software programs of a further device; and

FIGS. 4 to 8 show displays produced by a display of a diagnostic tool.

### DESCRIPTION OF THE EMBODIMENTS

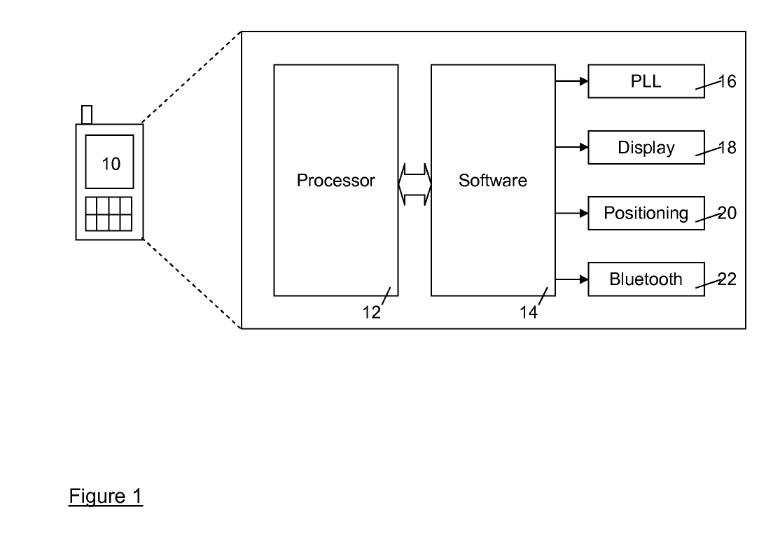

Referring to FIG. 1, a device, in this embodiment a mobile telephone handset, is shown generally at 10. The device 10 includes a processor 12 which executes software code, shown schematically at 14, to implement functionality of the device 10.

The device 10 includes a plurality of elements which consume power, or which control or influence elements which consume power. The elements shown in the device of FIG. 1 include a phase-locked loop oscillator element 16, a display element 18, a positioning system receiver element 20 and a Bluetooth® element 22, although it will be appreciated that the device 10 includes additional elements not illustrated. Each of the elements 16, 18, 20, 22 is controlled by the software code 14 which is executed by the processor 12. Thus, the software code 14 can activate or deactivate any of the elements 16, 18, 20, 22, or can cause one or more of the elements to change its state of operation.

Each of the elements of the device 10 may be viewed as a resource in abstract, or as a software resource comprising a software record of the state of the corresponding element.

In this embodiment, the display element 18 is a liquid crystal display (LCD), which has three operating modes: a full power state in which the LCD is fully illuminated, a low power state in which the brightness of the LCD's illumination is reduced in comparison to the full power state and a sleep state, in which the LCD is not illuminated but can be “awoken” quickly and caused to enter one of its other operating modes.

The software code 14 (which resides on a memory of the device 10 and which is processed by the processor) controls the operating state of the display element 18 in accordance with predefined requirements. For example, when the device 10 is in active use (e.g. when dialling a telephone number) the software code 14 causes the display element 18 to enter its full power state, so that a user of the device 10 can see a status message or the like on the LCD. If the device 10 is subsequently inactive for a predefined time period, for example ten seconds, the software code 14 may cause the display element 18 to enter its low power state, to conserve power whilst still allowing a user to view the LCD. If the display element has been in its low power state for a further predefined period, for example twenty seconds, the software code 14 may cause it to enter its sleep state, in which the LCD is not powered, so as to conserve power in the device 10.

The other elements 16, 20, 22 of the device 10 are managed in a similar way by the software code 14. Generally, the software code 14 manages the elements 16, 20, 22 as well as the processor 12 and, where the elements have more than one power state, sets the power state of these elements.

In certain situations, the software code may contain errors. Furthermore, the software code 14 may be operating in an inefficient manner (for example, by causing an element to consume more power than necessary). In order to contribute to the optimisation of the software code 14, this software code may undergo a “debugging” process, which may include, for example, ensuring that the software code 14 does not cause elements 16, 18, 20, 22 of the device 10 to be activated unnecessarily, and ensuring that the elements 16, 18, 20, 22 of the device 10 are maintained in an appropriate operating state where applicable.

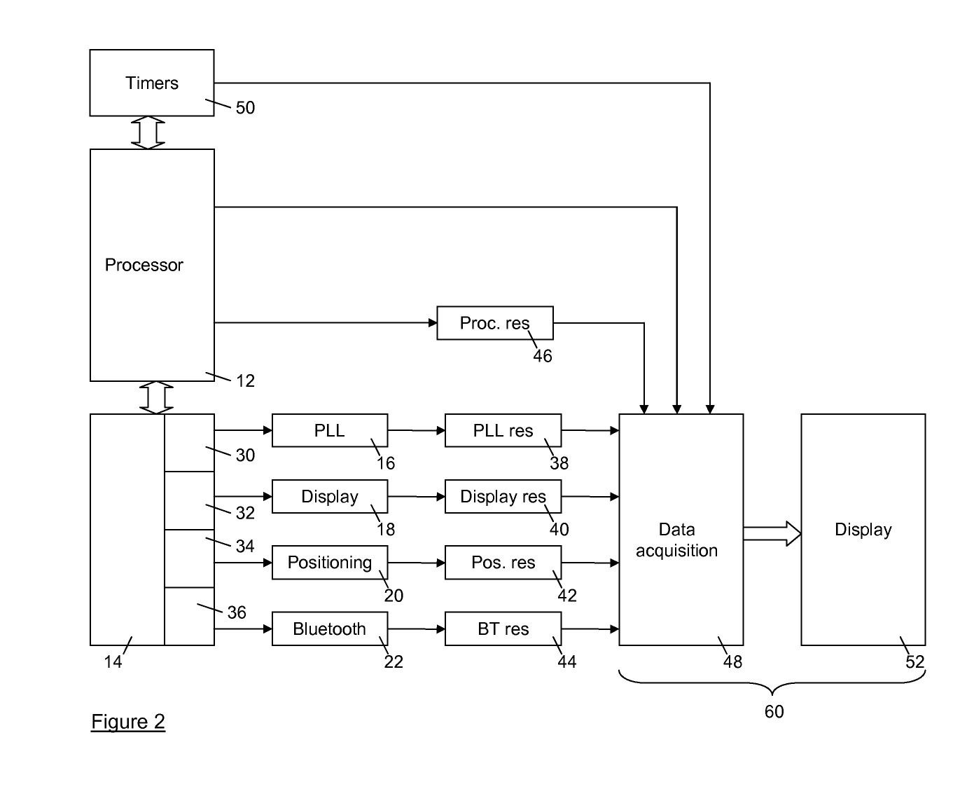

FIG. 2 is a schematic illustration showing the interactions between the software code 14 of the device 10 of FIG. 1 and a diagnostic tool according to an embodiment of the invention.

The software code 14 includes a plurality of programs 30, 32, 34, 36 which control the operation of the hardware elements 16, 18, 20, 22 and which change the operational state of these elements by issuing appropriate instructions. In this embodiment, the software programs 30, 32, 34 and 36 are device drivers. Therefore, software program 32 is a display driver which is used to control the operation of the display element 18. Software program 30 is a device driver for phase-locked loop oscillator element 16, software program 34 is a device driver for positioning system receiver element 20 and software program 36 is a device driver for Bluetooth® element 22.

Associated with each of the hardware elements 16, 18, 20, 22 are resource records 38, 40, 42, 44, which reflect the current operational state of the corresponding hardware element 16, 18, 20, 22 with which it is associated. In this embodiment, the resource records 38, 40, 42 and 44 are records of the operational states of the corresponding elements affecting the power consumption of those elements. In an alternate embodiment, the device drivers of the corresponding elements incorporate the record of the corresponding element and the acquisition module acquires the information directly from the device drivers.

In the embodiment illustrated, resource record 38 relates to the power states of the phase-locked loop oscillator element 16, resource record 40 relates to the power states of display element 18, resource record 42 relates to the power states of the positioning system receiver element 20, and resource record 36 relates to the power states of Bluetooth® element 22. When one of the elements 16, 18, 20 or 22 changes a power-related state (a change in operational state which alters the power consumption of that element), the new power state is recorded in the corresponding resource record. In this embodiment, the resources reflect the power-related states of the corresponding elements. In alternate embodiments other states may be reflected in the corresponding resource as well as, or instead of, the power-related states.

Display element 18 has three operating modes and the display resource record 40 will reflect one of three states: sleep, low-power and full power, depending upon the operating state of the display element 18.

A software resource record 46 is also associated with the processor 12, and this software processor resource record 46 reflects the operating state of the processor 12. In this respect it is to be realised that the processor may be viewed as an element of the device 10. In this embodiment the processor has five operating states: run, in which the processor 12 is running a piece of the software code 14; wait, in which the processor 12 is waiting for an event or external input; stop, in which the processor 12 has stopped running the software code 14 but is waiting for an event to cause it to start running a piece of the software code; doze, in which no action has been required of the processor 12 for a period of time so part of the processor's functionality has been deactivated to conserve power; and deep sleep state, in which no action has been required of the processor 12 for a longer period of time so the majority of the processor's functionality has been deactivated to reduce power consumption further. In this case, the processor resource 46 may adopt one of five states, run, wait, stop, doze and deep sleep state, depending upon the operational state of the processor 12.

With reference to FIG. 2 it is to be realised that the software code 14 causes the change of state of the processor 12 and the state is recorded by processor resource record 46.

The software resources are monitored by a data acquisition module 48, which in this embodiment is a piece of software which runs inside the device 10, but which may in alternate embodiments be run on an instrument, computer or the like which is external to the device 10.

Where the acquisition module is a piece of software which runs inside the device, the software of the device can easily be debugged even after the device has been manufactured, allowing the software to be modified to take into account unexpected power management issues that may arise in the manufacturing process.

The data acquisition module 48 collects data on the state of the elements 12, 16, 18, 20 and 22 reflected in corresponding software resource records 46, 38, 40, 42 and 44, and logs any change in the state of an element reflected in any one of the software resource records 38, 40, 42, 44, 46 against the time at which the change occurred.

By configuring the acquisition module to collect information relating to various parts of the device, a detailed profile of the power consumption of the device can be produced and displayed, allowing more effective debugging of the device software, as many different aspects of the software can be debugged. This in turn leads to improvements in the power efficiency of the device.

In an alternative embodiment a software module such as a power resource manager is provided to manage the resources 38, 40, 42, 44, 46, and this software module assigns a client identifier to each thread or program. This client identifier can be used to identify the software 30, 32, 34, 36 which caused the change in the software resource records 38, 40, 42, 44, 46, and in these cases this identifier is also logged by the data acquisition module 48. It will be understood by the skilled person that some software platforms will already allocate identifiers to clients; however, in other cases a client identifier could be generated or assigned specifically by the data acquisition module 48.

In the embodiment illustrated the portion of the software code 14 which causes the change of the operational state is identified by generating an identifier on the basis of the return address of the function call responsible for the change in power state made by the software code 14 to one or more of the programs 30, 32, 34, 36. This client identifier is the name of the program 30, 32, 34, 36, and can therefore be used to identify the programs 30, 32, 34, 36 which caused the change in the software resource records 38, 40, 42, 44, 46.

In alternate embodiments, the data acquisition module 48 logs the return address of the function call made by the software code 14 to one or more of the programs 30, 32, 34, 36. Alternatively, a registration system may be implemented whereby each of the programs 30, 32, 34 and 36 is assigned a number and the data acquisition module 48 records the number of the program causing the change in power state reflected in the resources.

By associating an identifier with one or more software programs a software program responsible for causing a change in the power consumption of the device can easily be identified by reference to the identifier.

The data acquisition module 48 also records information relating to events which affect the processor 12. For example, when an interrupt is asserted by the software code 14 the data acquisition module records an identifier of the interrupt and the time at which the interrupt occurred.

The data acquisition module 48 also records details of the timings at which the device 10 enters and exits low power modes. These details include an identifier identifying which of a plurality of low power modes was entered by the device 10, how long the device 10 remained in the low power state, and the reason for exiting the low power state, which is typically an interrupt received by the processor 12, in which case the identifier of the interrupt is recorded. Any other instruction from software code 14 causing a change in power state is also recorded, together with the time at which the instruction was issued. It is to be realised that in further embodiments other details pertaining to the operation of the device 10 may be recorded by the data acquisition module 48.

The device 10 includes a plurality of timer elements 50 which determine when events take place in the device 10. For example, a timer element 50 may be initiated on exiting a low power state of the device 10, causing the device 10 to re-enter the low power state when the timer element times out, by reaching a predetermined count or alternatively by counting down to zero from a predetermined value. The data acquisition module 48 records details of events associated with timer elements 50 including the time at which the timer element 50 was initiated, the expiry interval and periodicity of the timer element 50, the address of the line of the software code 14 which initiated the timer element 50, as well as the time at which the timer element 50 timed out.

The data acquisition module 48 is linked to a display 52, which in this embodiment is implemented as software running on processor 12, but which, in a further embodiment, is provided as part of an external instrument or computer.

The display 52 is configured to display the data acquired by the data acquisition module 48 against a common time base, permitting events affecting the power consumption of the device 10 and the elements of the device 10 to be visualised easily, thus facilitating the debugging of the software code 14 to improve the power consumption of the device. The display 52 can be configured to display a particular subset of the data acquired by the data acquisition module 48. In this embodiment, the diagnostic tool 60 comprises the acquisition module 48 and the display 52.

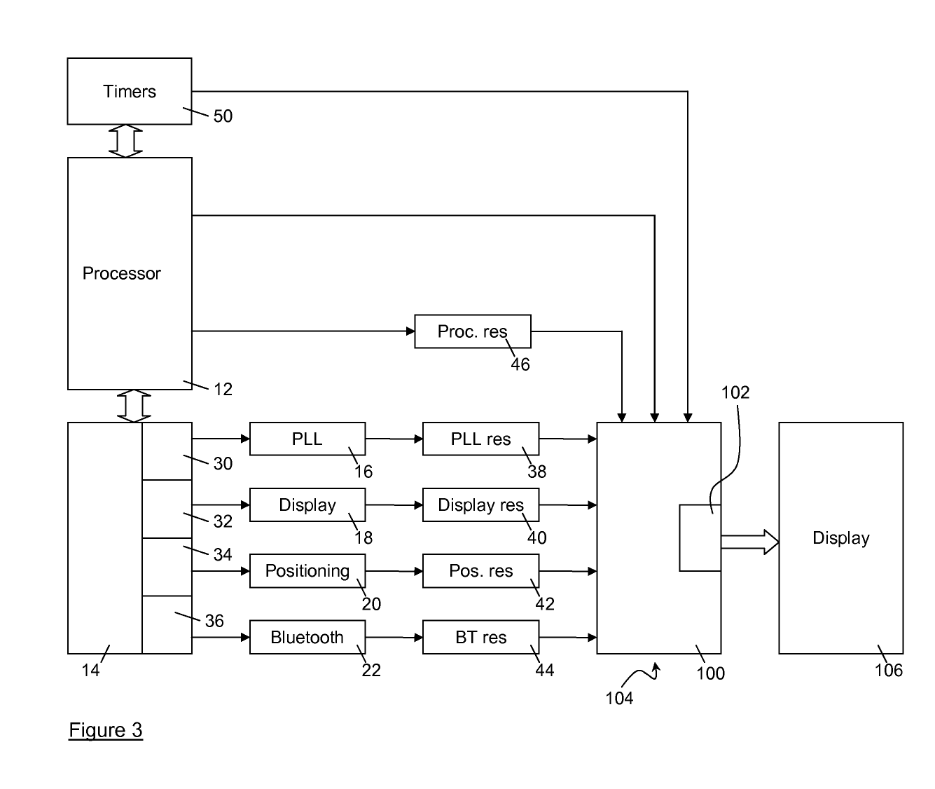

FIG. 3 is a schematic illustration showing the interactions between the software code 14 of a further device 10 and a diagnostic tool according to a further embodiment of the invention. In FIG. 3 like numerals have been used to label like components to those in FIG. 2. The embodiment of FIG. 3 differs from that of FIG. 2 in that a diagnostic tool 104 comprises an acquisition module 100 and display module 102. The acquisition module 100 operates in the same manner as the acquisition module 48 discussed above with reference to FIG. 2. However, in this embodiment, the display module 102 arranges the data acquired by the acquisition module 100 for display on display 106. The display module 102 receives the information collected by the acquisition module 100 and arranges this on a common time base, as well as ordering the information into sets corresponding to the elements to which the information pertains so that any one or more subsets may be selected for display on display 106.

In this embodiment, the display 106 is the display of the computing device where the processor 12 is located. In a further embodiment, the display is part of a computing device remote from the device on which processor 12 is located. Furthermore, it is to be realised that the display module 102 need not reside on the same computing device as the acquisition module 100 and in an alternate embodiment, display module 102 is remote from acquisition module 100.

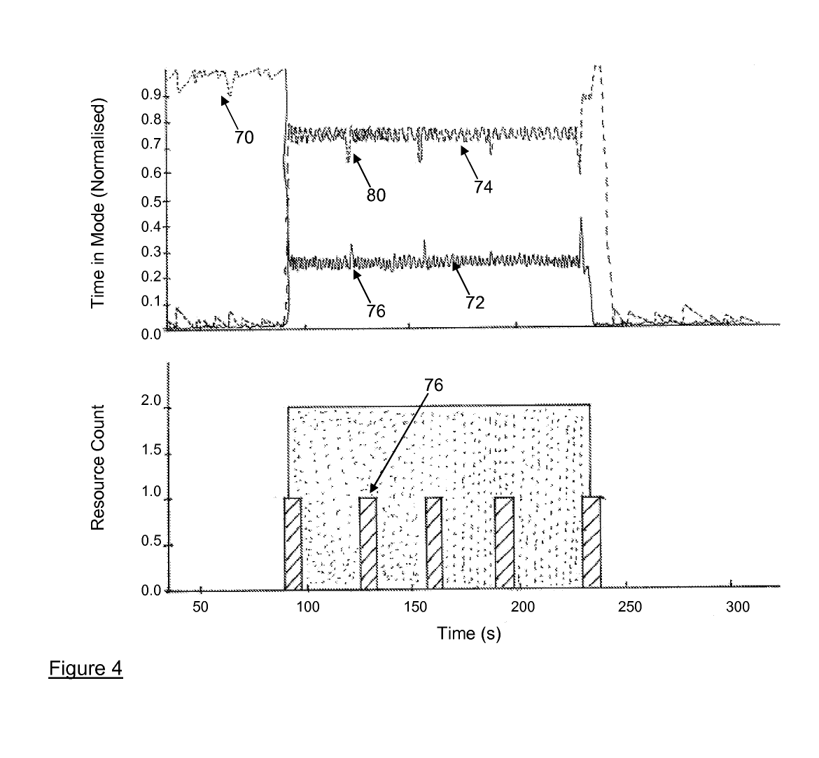

FIGS. 4 to 8 illustrate displays generated by the display 52 and are discussed in further detail below. Each of these Figures illustrate the effects of two hypothetical resources, resource A and resource B corresponding to elements on device 10 and the displays shown have been simplified to clarify the operation of certain embodiments of the invention. However, it is to be realised that the general principles of the discussion below applies to any of the elements and resources of the embodiments described above and, in particular, display 106 is capable of generating similar displays.

The display shown in FIG. 4 plots, on the upper graph, the percentage of time for which the processor 12 is in some of its operating state in a fixed time period, where the time t is indicated on the x-axis. Deep sleep state is indicated by a dotted line, doze state is indicated by a dashed line and run state is indicated by a solid line. The other two states of the processor 12, wait state and sleep state, are not shown on the display of FIG. 4 for clarity reasons, but it will be understood that traces of both modes may be displayed.

The lower graph of FIG. 4 plots resource counts of two different resources, resource A (shown with a diagonally hatched infill in FIG. 4) and resource B (shown with a dotted infill in FIG. 4), used by the device 10 against the same time base used in the upper graph. The resource counts are indicative of varying power-related states and the higher the count, the greater the power consumption of the element corresponding to that resource.

The display of FIG. 4 is a reference display from a test case where software running on a device has been optimised and there are no power management issues. It can be seen from the display that for the period up to t=90 (approximately), the system was idle. Neither of the elements corresponding to the resources being monitored was activated and the processor 12 was in its deep sleep state, as shown by the dotted line indicated by arrow 70. At approximately t=90 the resource count of resource A rises to 1, and soon after the resource count of resource B rises to 2. These events coincide with a change in the operating state of the processor 12. For the period between approximately t=90 and approximately t=235, the processor 12 is in its run state, for around 25 percent of the time, as shown by the solid line indicated by the arrow 72, and in its doze state for around 75 percent of the time, as indicated by the arrow 74. At a time t=235 approximately, the resource counts of both resource A and resource B have returned to zero, and the operating state of the processor has reverted to deep sleep state.

It will be observed that there are momentary peaks in the run state trace 72 and troughs in the doze state trace 74 which coincide with the change in the resource count of resource A from zero to 1. For example, at time t=125 approximately, the resource count of resource A rises from zero to 1, as indicated by arrow 76. At the same time, a peak 78 appears in the run state trace 72 and a trough 80 appears in the doze state trace 74. As these peaks and troughs are very small and last for only a very short period of time, it can be inferred that the use of resource A does not have a significant effect on the time spent by the processor 12 in its run state.

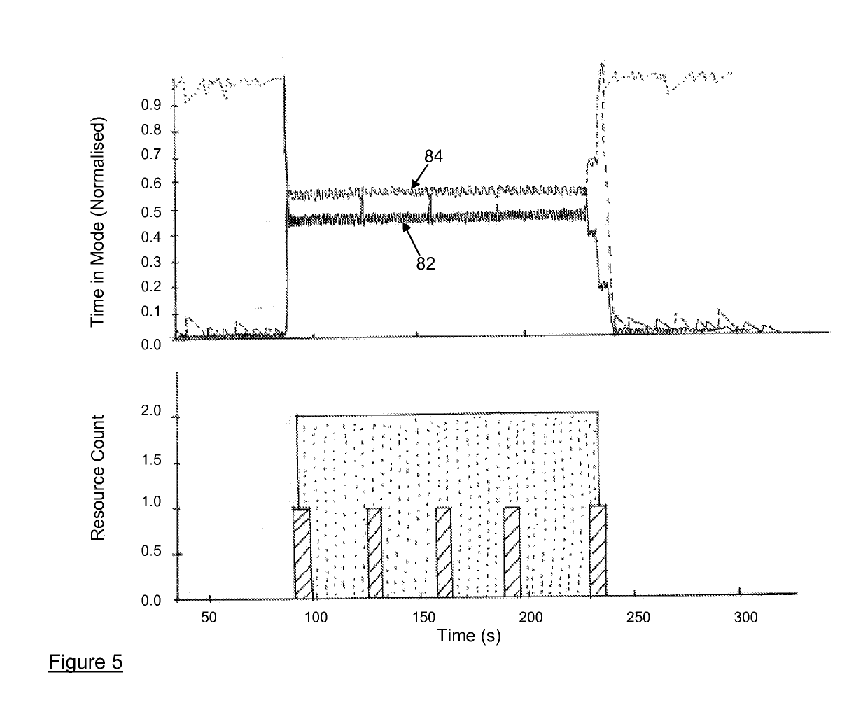

FIG. 5 shows a display where the processor 12 is operating in its run state for a prolonged period of time. This indicates that one or more of the software programs running on the processor 12 during this period may require optimising to reduce the length time for which the processor 12 operates in its run state.

The upper graph of FIG. 5 shows the time for which the processor 12 is in its run state (shown in solid line) and in its doze state (shown in dashed line), whilst the lower trace shows the resource count of two resources, resource A (shown in hatched infill) and resource B (shown in dotted infill). It can be seen that when the elements corresponding to one or both of resources A and B are operational (from approximately t=90 to approximately t=235) the processor 12 spends approximately 45 percent of the time in its run state, as indicated by arrow 82, and approximately 55 percent of the time in its doze state, as indicated by arrow 84. This may be indicative that one or more software programs issuing instructions to resource A and/or resource B or indeed another software program running on the processor 12 is not optimised, and would prompt a software engineer to investigate the software program(s) further to determine if there is an optimisation problem.

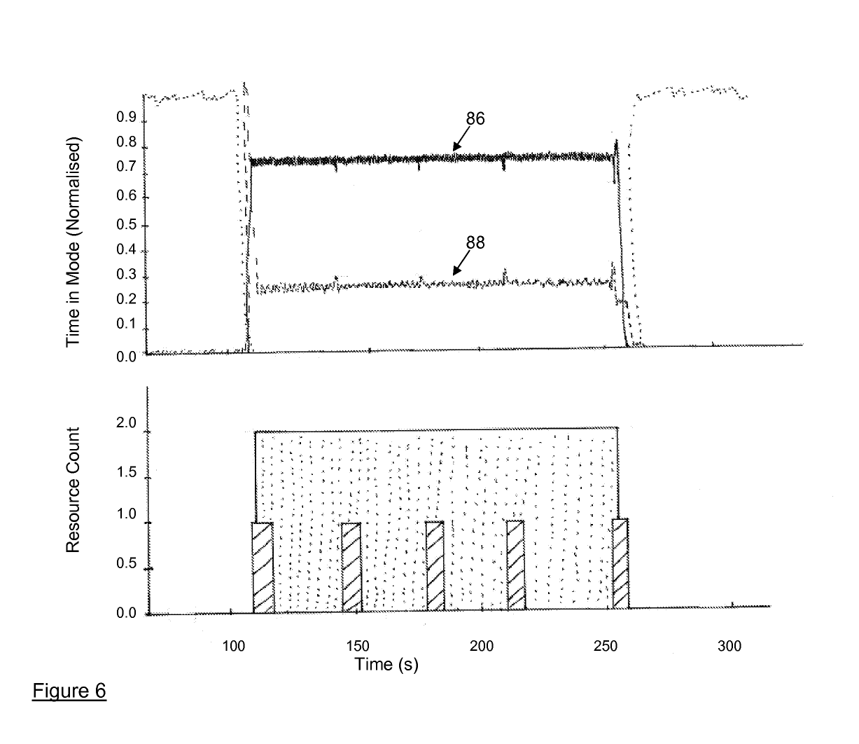

FIG. 6 shows graphs plotting the time for which the processor 12 is in its run state (shown in dashed line), wait state (shown in full line) and deep sleep state (shown in dotted line) and the resource count of two resources, resource A (shown in hatched infill) and resource B (shown in dotted infill) against a common time base.

In this example, the processor 12 is not able to enter as low an operating state as might be expected. In the example of FIG. 4, the processor 12 occupied its run state and its doze state when one or both of resources A and B were in use. In this case however, the processor 12 occupies its wait state for around 75 percent of the time, as indicated by arrow 86, and its run state for around 25 percent of the time, as indicated by arrow 88, when one or both of resources A and B are in operation during the period from approximately t=110 to approximately t=260. This may be indicative of an error in the resources or in a software program that is running on the processor 12, or a defect in hardware, as it might be expected that the processor 12 would be able to occupy its doze state rather than its wait state, as in the example of FIG. 4. Thus, a software engineer viewing the display of FIG. 6 would be prompted to investigate the software programs running on the processor 12 and the hardware to identify if this may be optimised.

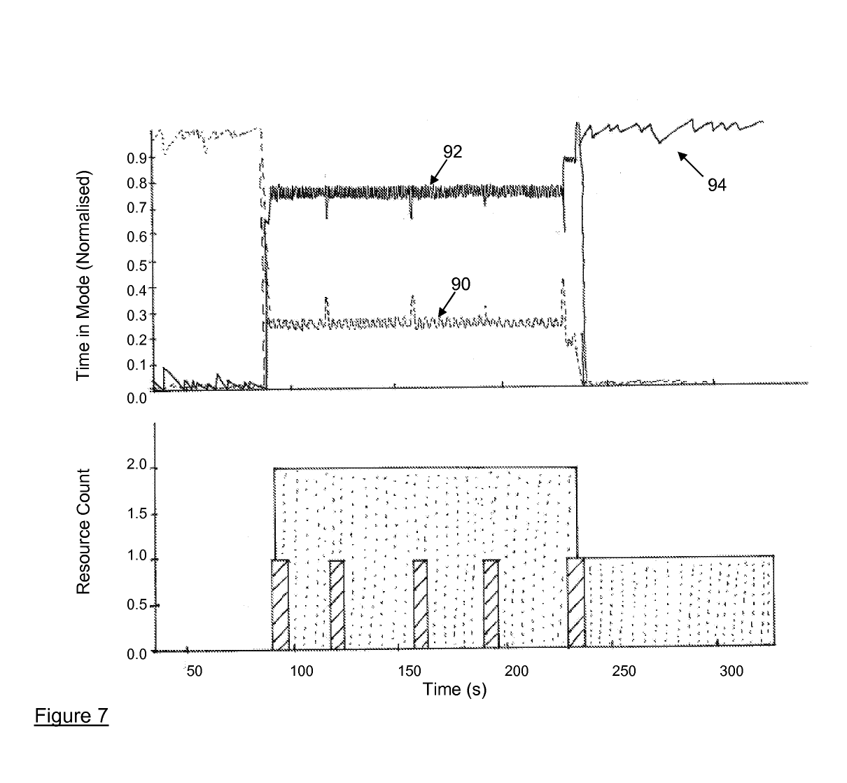

FIG. 7 illustrates a case where an element is not properly released by a software program after use. The upper graph of FIG. 7 shows the time for which the processor 12 occupies its doze state in solid line and the time for which the processor 12 occupies its run state in dashed line. The lower graph of FIG. 7 shows the resource counts of resources A and B against the same time base as the upper graph.

During the period from t=90 approximately to t=235 approximately the processor 12 occupies its run state for around 25 percent of the time, as indicated by arrow 90, and its doze state for around 75 percent of the time, as indicated by arrow 92.

At approximately t=235, the resource count of resource A drops to zero and the resource count of resource B drops to 1. At the same time, the time spent by the processor 12 in its doze state increases to between 90 and 100 percent, as indicated by arrow 94. The reduction in the resource count of resource B from 2 to 1 indicates that resource B has not been properly updated by a software program, thus preventing the processor 12 from reverting completely to its lowest power (deep sleep) state of operation. Such a situation may arise, for example, if a device driver software program had not updated resource B (by issuing instructions for resource B to enter the correct state), or an application had not closed the device driver correctly, and would prompt a software engineer to investigate such software programs with a view to rectifying the fault and optimising the software program.

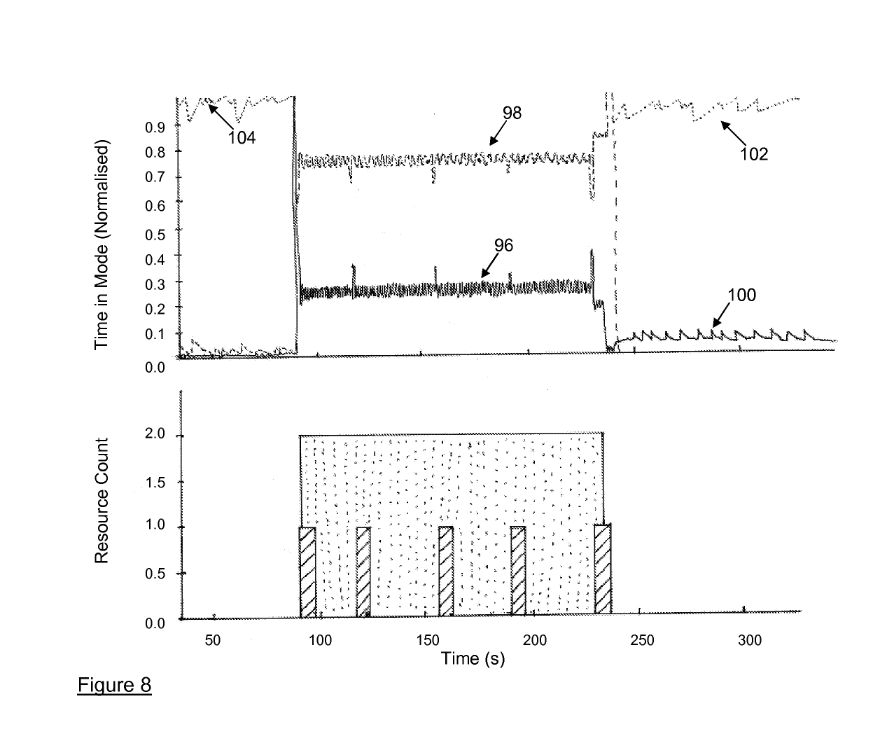

FIG. 8 illustrates a situation in which a software program has not shut down correctly, preventing the processor 12 from entering its deep sleep state fully.

The upper graph of FIG. 8 shows the run state of the processor 12 in solid line, the doze state as a dashed line and the deep sleep state as a dotted line. The resource counts of resources A and B are shown (in diagonal infill and dotted infill respectively) on the lower graph against the same time base as is used in the upper graph.

It will be seen that for the period from t=90 approximately to t=235 approximately, where one or both of resources A and B are in use, the processor 12 occupies its run state for around 25 percent of the time, as indicated by arrow 96, and its doze state for around 75 percent of the time, as indicated by arrow 98. When neither of resources A or B is in use, after around t=235, the processor 12 might be expected to revert completely to its deep sleep state. However, in this case the processor 12 occupies its doze state for up to around 8 percent of the time, as indicated by arrow 100, and its deep sleep state for as little as 92 percent of the time, as indicated by arrow 102. This contrasts with the situation that existed in the time up to around t=90, before either of the resources were activated, when the processor 12 occupied its deep sleep state for much more of the time, as indicated by arrow 104.

A software engineer viewing the display of FIG. 8 would immediately discount resources A and B as the possible cause of this optimisation error, and would be prompted to investigate the software running on the processor 12 to ascertain the cause of the problem. A graphical display showing interrupts against the time base used in the display of FIG. 8 may be used to confirm this and to aid optimisation and debugging of the software.

In the graphs illustrated in FIGS. 4 to 8 a comparison is made between the operation of resources A and B and the power state of the processor. It is to be realised however, that the display may be configured to compare resource A against resource B, or that the operation of one or more resources may be compared to the power state of the device 10.

It will be appreciated that it is generally preferable to analyse source code rather than object code in a debugging exercise of this type, so references to examining code are generally intended to mean source code, although the examination of object code is also within the scope of the invention. It will also be appreciated that the term “program” as used herein could refer to a relatively large body of code such as an entire component, or it could refer to software instructions of any length or type.

The display 52 can be configured to display the estimated total power consumption of the device 10 by using information gathered by measurement or provided by manufacturers of the processor 12 and the elements 16, 18, 20, 22 of the device 10 on their power consumption in each of their different operating modes in conjunction with the data acquired by the data acquisition module 48. Likewise, display module 102 can be configured in a similar manner.

Where the estimated total power consumption of the device 10 is displayed, the total power consumption of the device at a given time can be estimated, and software programs causing a change in the total power consumption of the device can be identified.

The diagnostic tool of example embodiments of the present invention allows a plurality of resources (and therefore elements of devices such as device 10) to be monitored simultaneously and their status displayed in a manner that permits easy identification of a software program which is responsible for a change in the power consumption of the device, so that the software program can be altered if appropriate to reduce the power consumption of the device. As the data acquisition module keeps a record of the software program which causes a change in a resource as well as a record of the time when the change occurred, once a user has identified an anomalous power state change, the software program causing this change may be identified.

It will be appreciated that the display 52, or display module 102, allows data acquired by the data acquisition module 48 to be displayed against a common time base, permitting quick identification of events which affect the power consumption of the device, and thus quick identification of the software programs which are responsible for changes in the power consumption of the device 10. Having identified the responsible software programs, the software code 14 can be changed to improve the overall power consumption of the device 10.

Although the embodiments described above relate to debugging software code of a mobile telephone handset, it will be appreciate that further embodiments of the present invention are equally applicable to any computing device which uses software code running on a processor.

It will be understood by the skilled person that alternative implementations are possible, and that various modifications of the methods and implementations described above may be made within the scope of the invention, as defined by the appended claims. It should also be noted that any combination of the features and process elements described herein may be combined or omitted in different embodiments of the invention.

1. Apparatus comprising:
at least one processor
and at least one memory including computer program code
the at least one memory and the computer program code configured to, with the at least one processor, cause the apparatus to:
collect information using an acquisition module, said information relating to a plurality of elements of a computing device having two or more operational states, said information relating to a change of an operational state of said elements, said computing device further comprising one or more software programs which change an operational state of at least one of said elements, and
arrange said information for display of an operational state of the elements against a common time base.

2. Apparatus according to claim 1 wherein at least one of the elements has an identifier associating the element with one or more of said software programs.

3. Apparatus according to claim 1 wherein the information is arranged to display an estimate of the total power consumption of the computing device against the common time base.

4. Apparatus according to claim 1 wherein the acquisition module is a piece of software which runs inside the computing device.

5. Apparatus according to claim 1 wherein the acquisition module is configured to collect information relating to events which affect a processor of the computing device.

6. Apparatus according to claim 1 wherein the data acquisition module is configured to collect information relating to power modes of the computing device.

7. Apparatus according to claim 6 wherein the information is arranged to display the information relating to power modes of the computing device and the information relating to the elements against the common time base.

8. Apparatus according to claim 1 wherein the data acquisition module is configured to collect information relating to timers of the computing device.

9. A method comprising:
collecting information with use of an acquisition module, said information relating to a plurality of elements of a computing device having two or more operational states, said information relating to a change of an operational state of said elements, said computing device further comprising one or more software programs which change a state of at least one of said elements, and
arranging said information for display of an operational state of the elements against a common time base.

10. A method according to claim 9 wherein at least one of the elements has an identifier associating the element with one or more software programs.

11. A method according to claim 9 wherein said information is arranged to display an estimate of the total power consumption of the computing device against the common time base.

12. A method according to claim 9 wherein the data acquisition module is a piece of software which runs inside the computing device.

13. A method according to claim 9 wherein information relating to events which affect a processor of the computing device is collected by the data acquisition module.

14. A method according to claim 9 wherein information relating to power modes of the computing device is collected by the data acquisition module.

15. A method according to claim 14 wherein the information relating to power modes of the computing device and the information relating to the elements are arranged for display against the common time base.

16. A method according to claim 9 wherein information relating to timers of the computing device is collected by the data acquisition module.

17. A computer readable medium storing instructions, said instructions being such that when processed by a processor configure said processor to:
collect information relating to a plurality of elements of a computing device having two or more operational states, said information relating to a change of an operational state of said elements, said computing device further comprising one or more software programs which change an operational state of at least one of said elements, and
arrange said information for display of an operational state of the elements against a common time base.

18. The computer readable medium according to claim 17 wherein said processor operates in a computing device different from the computing device in respect of which the information is collected.

19. The computer readable medium according to claim 17 wherein the processor operates on the same computing device in respect of which the information is collected.

20. (canceled)

21. A method comprising:
monitoring a power state of at least a first and a second hardware component of a computing device, said power state of said first hardware component being alterable by one or more software instructions,
comparing a change in said power state of said first hardware component to said power state of said second hardware component, and
identifying a software instruction which caused said change of said power state of said first hardware component.

22. (canceled)
